(19) United States
(12) Patent Application Publication
(10) Pub. No.: US 2015/0341380 A1
(43) Pub. Date: Nov. 26, 2015

(54) SYSTEM AND METHOD FOR DETECTING ABNORMAL BEHAVIOR OF CONTROL SYSTEM

(71) Applicant: Electronics and Telecommunications Research Institute, Daejeon (KR)

(72) Inventors: Young Jun HEO, Daejeon (KR); Seon Gyoung SOHN, Daejeon (KR); Byoung Koo KIM, Daejeon (KR); Dong Ho KANG, Daejeon (KR); Jung Chan NA, Daejeon (KR)

(21) Appl. No.: 14/667,137

(22) Filed: Mar. 24, 2015

(30) Foreign Application Priority Data
May 20, 2014 (KR) 10-2014-0060364

(51) Int. Cl. H04L 29/06; G06F 17/30

(52) U.S. Cl. CPC H04L 63/1425; H04L 63/1458; G06F 17/30598

(57) ABSTRACT

Provided are a system and method for detecting an abnormal behavior of a control system by analyzing flows of the control system. Flow information of the control network is collected, and flows are classified according to the collected flow information and a flow group is generated. An abnormal behavior of the control system is detected by analyzing flows of the generate flow group. That is, internal systems of the control network are grouped according to functions, and a situation of a system of a group performing the same function is managed to thus quickly detect an abnormal behavior of the control system.

### CROSS-REFERENCE TO RELATED APPLICATIONS

This application claims priority to and the benefit of Korean Patent Application No. 10-2014-0060364, filed on May 20, 2014, the disclosure of which is incorporated herein by reference in its entirety.

### TECHNICAL FIELD

The present invention relates to a system and method for detecting an abnormal behavior generated in a control system forming a control network, and more particularly, to a system and method for detecting an abnormal behavior generated due to a denial-of-service (DoS) attack on or an unauthorized access to a control system, a network configuration error, equipment fault, and the like.

### BACKGROUND

A control network includes control equipment such as a PLC, RTU, HMI, a server, and the like, and network equipment such as a switch, a router, and the like, and these equipment has been digitized and open, and use Ethernet-based IP communication.

Due to this trend, attacks such as denial-of-service (DoS) attack, an unauthorized access, and the like, which largely have taken place in Ethernet communication, also frequently occurs in control systems, and a possibility of large-scale physical disaster due to a cyber attack threat and cyber terror targeting control systems is on the rise. Stuxnet attack targeting industrial facilities has already been made as a typical cyber attack.

Control systems gradually tend to use open software and standard communication protocols. Thus, a great deal of knowledge on operations of control systems are provided to attackers, increasing the possibility and risk of cyber infringement on control systems, and thus, importance of security of control systems is growing.

Security systems are provided to protect systems against cyber infringement. However, in a related art security scheme, security products such as a firewall, an intrusion detection system, and the like, for protecting control systems are positioned in an external network boundary, providing boundary-centered security measures, which is vulnerable to problems generated in an internal infrastructure.

### SUMMARY

Accordingly, the present invention provides a system and method for detecting an abnormal behavior generated in a control system by grouping flows of a control network according to a source address, a service port, a destination address, and the like, and analyzing an amount of traffic, a traffic transmission time, a transmission interval between the same traffic, and the like, regarding a source address system of each group.

In one general aspect, a system for detecting an abnormal behavior of a control system includes: a flow information collector configured to collect flow information within a control network; a flow classifier configured to classify flows according to the collected flow information and generate a flow group; and an abnormal behavior analyzer configured to analyze a pattern of a flow included in the flow group and detect an abnormal behavior of the control network according to the analysis result.

The abnormal behavior analyzer may determine whether a destination address of a flow included in the flow group is permitted or not, and when the destination address of the flow is not a permitted destination address, the abnormal behavior analyzer may detect an abnormal behavior of a source address of the flow.

The abnormal behavior analyzer may determine whether a service port of a flow included in the flow group is permitted or not permitted for the flow group, and the abnormal behavior analyzer may detect an abnormal behavior of the source address of the flow.

The abnormal behavior analyzer may calculate a transmission time of a flow included in the flow group, and when the calculated transmission time is not within a predetermined range from a transmission time of a different flow included in the flow group, the abnormal behavior analyzer may detect an abnormal behavior of the source address.

The abnormal behavior analyzer may calculate a packet size of a flow included in the flow group, and when the calculated packet size is not within a predetermined range from a packet size of a different flow included in the flow group, the abnormal behavior analyzer may detect an abnormal behavior of the source address.

The abnormal behavior analyzer may calculate a difference between a request time and a response time of a flow included in the flow group, and when the calculated difference is not within a preset range, the abnormal behavior analyzer may detect an abnormal behavior of the destination address.

The abnormal behavior analyzer may calculate a request time interval of a flow included in the flow group, and when the calculated request time interval is not within a preset range, the abnormal behavior analyzer may detect an abnormal behavior of the source address.

The flow classifier may classify a flow included in the collected flow information by using at least one of a source address, a destination address, and a service port of the flow, and determine the number of flow groups generated according to services or operations performed within the control network.

In another aspect, a method for detecting an abnormal behavior of a control system includes: collecting flow information within a control network; classifying flows according to the collected flow information and generating a flow group; analyzing a pattern of a flow included in the flow group and detecting an abnormal behavior within the control network according to the analysis result; and when an abnormal behavior within the control network is detected, providing information regarding the detected abnormal behavior.

Other features and aspects will be apparent from the following detailed description, the drawings, and the claims.

### BRIEF DESCRIPTION OF THE DRAWINGS

FIG. 1 is a block diagram illustrating a structure of a system for detecting an abnormal behavior of a control system according to an embodiment of the present invention.

FIG. 2 is a view illustrating classification of flows of a control network by the system for detecting an abnormal behavior of a control system according to an embodiment of the present invention.

FIGS. 3 through 7 are flow charts illustrating a process of detecting an abnormal behavior through flow information analysis by the system for detecting an abnormal behavior of a control system according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings.

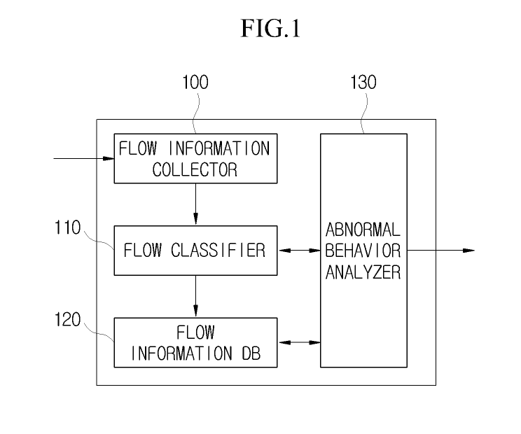

FIG. 1 is a block diagram illustrating a structure of a system for detecting an abnormal behavior of a control system according to an embodiment of the present invention.

The system for detecting an abnormal behavior of a control system according to an embodiment of the present invention includes a flow information collector 100, a flow classifier 110, a flow information database (DB) 120, and an abnormal behavior analyzer 130.

The flow information collector 100 collects flow information of a control network and delivers the collected flow information to the flow classifier 110. The flow information collector 100 collects information such as a source address, a service port (a destination port number), and a destination address of a flow of the control network.

The flow classifier 110 groups the flow of the control network according to the flow information delivered from the flow information collector 100, generating a flow group. The flow classifier 110 groups the flow using at least one of the source address, the service port, and the destination address of the flow of the control network, and the number of generated groups is determined according to services or operations performed in the control system.

In terms of characteristics of the control system, systems of the same group perform a predetermined operation to execute the same function. That is, messages transmitted and received between source and destination systems in the same group are packets executing the same function, in which a packet size, a packet transmission period, an interval between packets, protocols, and the like, between the systems have the same pattern. Thus, in the present invention, flows are grouped according to flow information and flows of the same group are analyzed to detect an abnormal behavior in the control network.

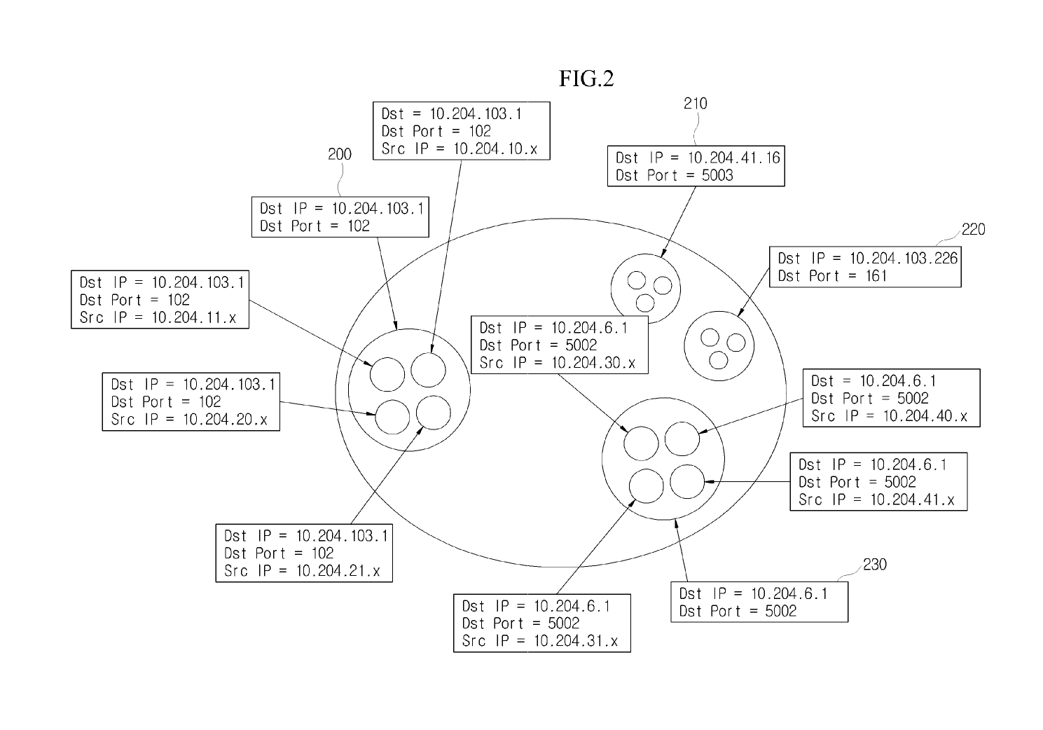

FIG. 2 is a view illustrating classification of flows of a control network by the flow classifier 110.

The flow classifier 110 classifies a flow of the control network on the basis of a source address, a service port, a destination address, and the like. In FIG. 2, it is illustrated that flows are classified into four flow groups on the basis of destination addresses and service ports.

For example, flow group 200 is a flow group generated by grouping flows having a destination address Dst IP of 10.204.103.1 and a service port No. 102, and flow group 210 is a flow group generated by grouping flows having a destination address 10.204.41.16 and a service port No. 5003.

The flow classifier 110 stores information regarding the generated flow group and flow information in the flow information DB 120.

The flow information DB 120 stores the flow group generated by the flow classifier 110 and the flow, and provides the stored information to the abnormal behavior analyzer 130.

The abnormal behavior analyzer 130 analyzes the flow information of the flow group stored in the flow information DB 120 and detects an abnormal behavior in the control system in advance. Here, the abnormal behavior analyzer 130 detects an abnormal behavior of a control system by analyzing a destination address, a transmission time, a packet size, a request/response time, a request time interval, and the like.

Here, whenever it is determined that the flow analyzer 110 has generated a new flow group or whenever a generated flow group has been updated, the abnormal behavior analyzer 130 may analyze a flow of the flow group.

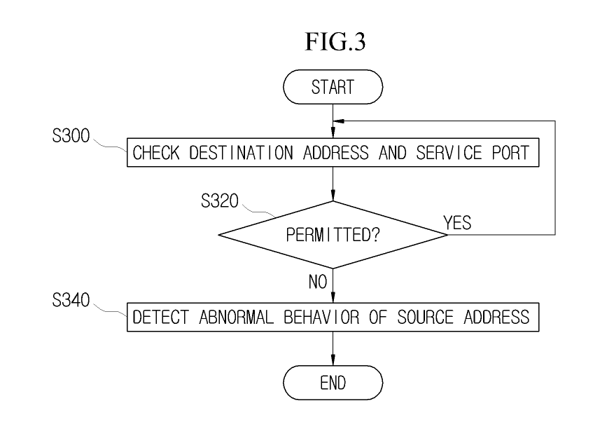

FIGS. 3 through 7 are flow charts illustrating a process of detecting an abnormal behavior by the abnormal behavior analyzer 130.

FIG. 3 is a view illustrating that the abnormal behavior analyzer 130 detects an abnormal behavior of the control network by analyzing a destination address or a service port of a flow of a flow group.

The abnormal behavior analyzer 130 determines whether a destination address or a service port has the authority in step S300. That is, the abnormal behavior analyzer 130 determines whether the destination address or the service port is a permitted destination address or a permitted service port. When the destination address is not a permitted address or when the service port is not a permitted service port in step S320, the abnormal behavior analyzer 130 detects an abnormal behavior of a source address in step S340.

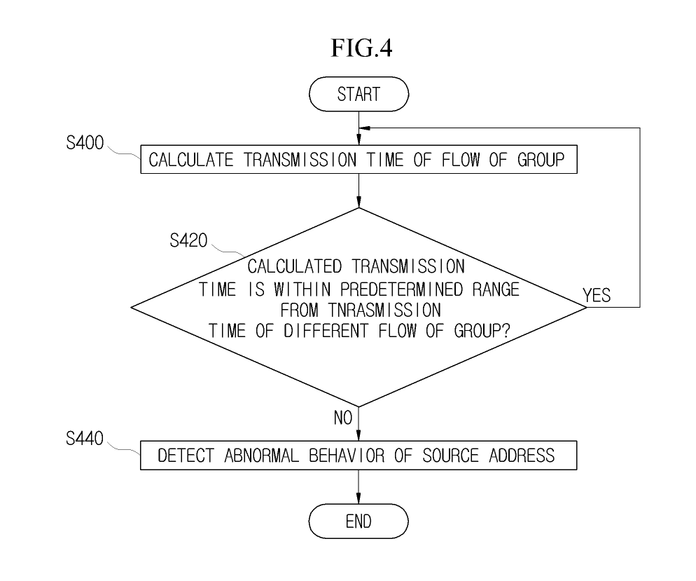

FIG. 4 is a view illustrating that the abnormal behavior analyzer 130 detects an abnormal behavior of the control network by analyzing a transmission time of a flow of a flow group.

The abnormal behavior analyzer 130 calculates a transmission time of a flow of a flow group in step S400. The abnormal behavior analyzer 130 compares the calculated transmission time with a transmission time of a different flow of the same flow group, and when the calculated transmission time is not within a predetermined range from the transmission time of the different flow in step S420, the abnormal behavior analyzer 130 detects an abnormal behavior of a source address in step S440. Alternatively, the abnormal behavior analyzer 130 may analyze the flow according to whether the calculated transmission time is equal to the transmission time of the different flow, and detect an abnormal behavior.

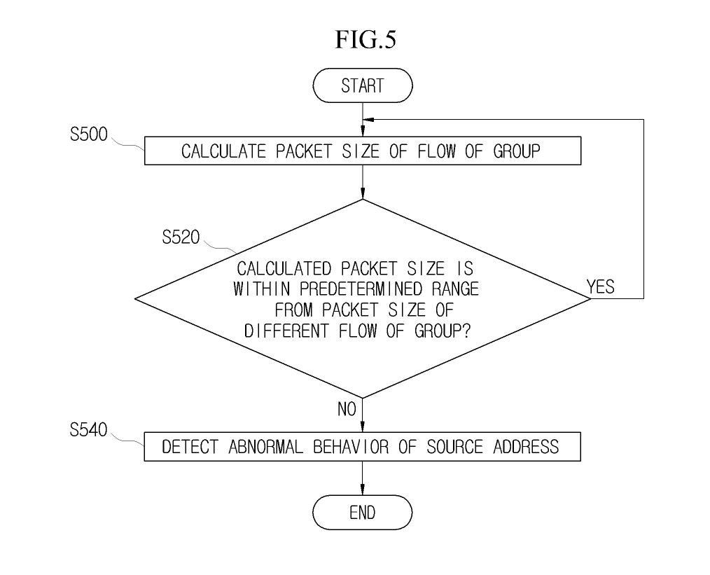

FIG. 5 is a view illustrating that the abnormal behavior analyzer 130 detects an abnormal behavior of the control network by analyzing a packet size of a flow of a flow group.

The abnormal behavior analyzer 130 calculates a packet size of a flow of a flow group in step S500. The abnormal behavior analyzer 130 compares the calculated packet size with a packet size of a different flow of the same flow group. When the calculated packet size is not within a predetermined range from the packet size of the different flow in step S520, the abnormal behavior analyzer 130 detects an abnormal behavior of a source address in step S540. Alternatively, the abnormal behavior analyzer 130 may analyze the flow according to whether the calculated packet size is equal to the packet size of the different flow, and detect an abnormal behavior.

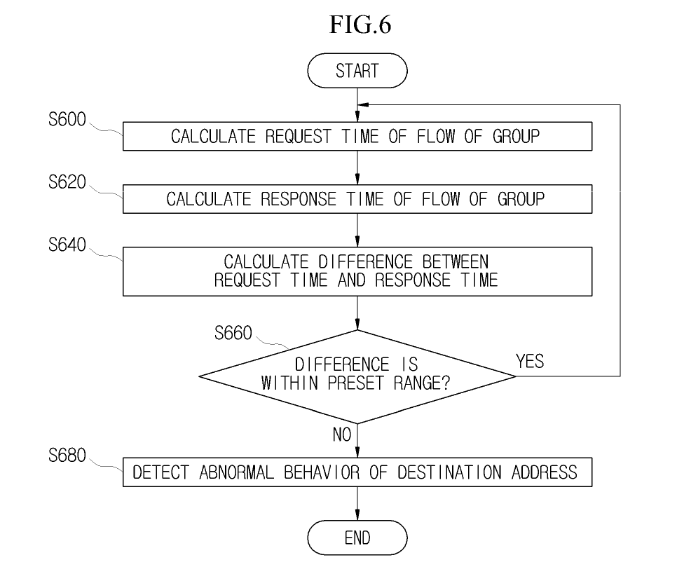

FIG. 6 is a view illustrating that the abnormal behavior analyzer 130 detects an abnormal behavior of the control network by analyzing a difference between a request time and a response time of a flow of a flow group.

The abnormal behavior analyzer 130 calculates a request time of a flow of a flow group in step S600 and calculates a response time in step S620. The abnormal behavior analyzer 130 calculates a difference between the request time and the response time in step S640 and determines whether the difference is within a preset time range in step S660. When the difference between the request time and the response time is not within the preset range, the abnormal behavior analyzer 130 detects an abnormal behavior of a destination address in step S680.

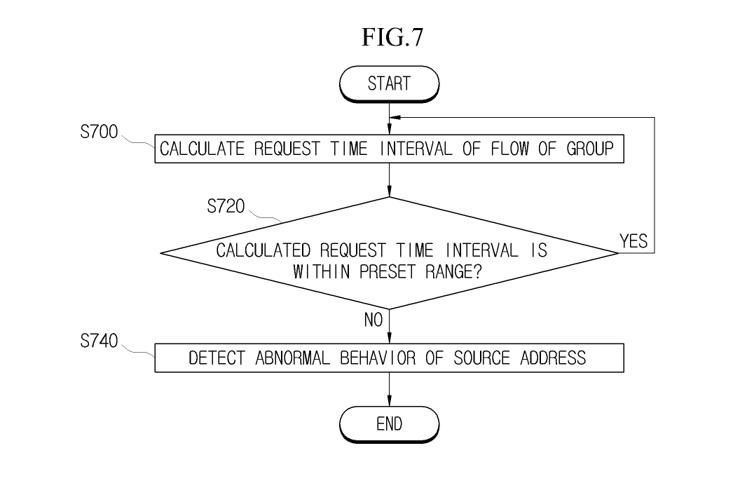

FIG. 7 is a view illustrating that the abnormal behavior analyzer 130 detects an abnormal behavior of the control network by analyzing a request time interval of a flow of a flow group.

The abnormal behavior analyzer 130 calculates a request time interval of a flow of a flow group in step S700, and determines whether the calculated request time interval is within a preset range in step S720. When the request time interval is not within the preset range, the abnormal behavior analyzer 130 detects an abnormal behavior of a source address in step S740.

The abnormal behavior analyzer 130 detects an abnormal behavior of the control signal by using at least one of the flow analysis methods described above, and when an abnormal behavior of the control network is detected, the abnormal behavior analyzer 130 provides information regarding the detected abnormal behavior. Thus, an attack to the control system can be prevented in advance by rapidly detecting an abnormal behavior.

According to the present invention, by grouping traffic information of a control network and analyzing flows having the same characteristics of a group, an abnormal behavior of the control system can be detected. Also, by grouping internal systems of the control network according to functions and managing a situation of a system of a group executing the same function, an attack can be recognized in advance by rapidly detecting an abnormal behavior of the control system, thus guaranteeing availability of the control system.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for detecting an abnormal behavior of a control system, the system comprising:
a flow information collector configured to collect flow information within a control network;
a flow classifier configured to classify flows according to the collected flow information and generate a flow group; and
an abnormal behavior analyzer configured to analyze a pattern of a flow included in the flow group and detect an abnormal behavior of the control network according to the analysis result.

2. The system of claim 1, wherein the abnormal behavior analyzer determines whether a destination address of a flow included in the flow group is a designation address permitted for the flow group, and when the destination address of the flow is not a permitted destination address, the abnormal behavior analyzer detects an abnormal behavior of a source address of the flow.

3. The system of claim 1, wherein the abnormal behavior analyzer determines whether a service port of a flow included in the flow group is a service port permitted for the flow group, and when the service port of the flow is not a permitted service port, the abnormal behavior analyzer detects an abnormal behavior of the source address of the flow.

4. The system of claim 1, wherein the abnormal behavior analyzer calculates a transmission time of a flow included in the flow group, and when the calculated transmission time is not within a predetermined range from a transmission time of a different flow included in the flow group, the abnormal behavior analyzer detects an abnormal behavior of the source address.

5. The system of claim 1, wherein the abnormal behavior analyzer calculates a packet size of a flow included in the flow group, and when the calculated packet size is not within a predetermined range from a packet size of a different flow included in the flow group, the abnormal behavior analyzer detects an abnormal behavior of the source address.

6. The system of claim 1, wherein the abnormal behavior analyzer calculates a difference between a request time and a response time of a flow included in the flow group, and when the calculated difference is not within a preset range, the abnormal behavior analyzer detects an abnormal behavior of the destination address.

7. The system of claim 1, wherein the abnormal behavior analyzer calculates a request time interval of a flow included in the flow group, and when the calculated request time interval is not within a preset range, the abnormal behavior analyzer detects an abnormal behavior of the source address.

8. The system of claim 1, wherein whenever it is determined that the flow classifier has generated or updated the flow group, the abnormal behavior analyzer analyzes a pattern of a flow included in the flow group.

9. The system of claim 1, wherein the flow classifier classifies the flows using at least one of a source address, a destination address, and a service port of the flows included in the collected flow information.

10. The system of claim 1, wherein the flow classifier determines the number of flow groups generated according to services or operations performed within the control network.

11. The system of claim 1, wherein the flow information collector collects a source address, a destination address, and a port within the control network.

12. A method for detecting an abnormal behavior of a control system, the method comprising:
collecting flow information within a control network;
classifying flows according to the collected flow information and generating a flow group;
analyzing a pattern of a flow included in the flow group and detecting an abnormal behavior within the control network according to the analysis result; and
when an abnormal behavior within the control network is detected, providing information regarding the detected abnormal behavior.

13. The method of claim 12, wherein the detecting of an abnormal behavior within the control network according to the analysis result comprises:
determining whether a destination address of a flow included in the flow group is a destination address permitted for the flow group, and when the destination address of the flow is not a permitted destination address, determining whether a source address of the flow has been permitted.

14. The method of claim 12, wherein the detecting of an abnormal behavior within the control network according to the analysis result comprises:
determining whether a service port of a flow included in the flow group is a service port permitted for the flow group, and when the service port of the flow is not a permitted service port, determining whether a source address of the flow has been permitted.

15. The method of claim 12, wherein the detecting of an abnormal behavior within the control network according to the analysis result comprises:
calculating a transmission time of a flow included in the flow group, and when the calculated transmission time is not within a predetermined range from a transmission time of a different flow included in the flow group, detecting an abnormal behavior of the source address.

16. The method of claim 12, wherein the detecting of an abnormal behavior within the control network according to the analysis result comprises:
calculating a packet size of a flow included in the flow group, and when the calculated packet size is not within a predetermined range from a packet size of a different flow included in the flow group, detecting an abnormal behavior of the source address.

17. The method of claim 12, wherein the detecting of an abnormal behavior within the control network according to the analysis result comprises:
calculating a difference between a request time and a response time of a flow included in the flow group, and when the calculated difference is not within a preset range, detecting an abnormal behavior of the destination address.

18. The method of claim 12, wherein the detecting of an abnormal behavior within the control network according to the analysis result comprises:
calculating a request time interval of a flow included in the flow group, and when the calculated request time interval is not within a preset range, detecting an abnormal behavior of the source address.

19. The method of claim 12, wherein the generating of a flow group comprises:
classifying the flows using at least one of a source address, a destination address, and a service port of the flows included in the collected flow information.

20. The method of claim 12, wherein the generating of a flow group comprises:
determining the number of flow groups generated according to services or operations performed within the control network.
